(19) United States
(12) Patent Application Publication
(10) Pub. No.: US 2007/0159484 A1
(43) Pub. Date: Jul. 12, 2007

(54) Method for processing computer aided polygon model

(76) Inventor: Juha Paaso, Vantaa (FI)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/593,673

(22) PCT Filed: Mar. 22, 2005
(86) PCT No.: PCT/FI05/50101

§ 371 Date: Sep. 20, 2006

(30) Foreign Application Priority Data
Mar. 25, 2004 (FI) 20045098

(51) Int. Cl. G06T 11/20

(52) U.S. Cl. 345/441

(57) ABSTRACT

The invention relates to a method for processing a computer aided polygon model, and to a device and computer program for implementing the method. The invention comprises presenting the polygon model with a linear and static vertex array (304A) and with a linear index array (306A) including vertex array pointers. The hierarchical information on the vertices of the polygon model part to be presented graphically is included in a hierarchical data structure (302A) pointing indirectly at the vertices of the vertex array (304A) through the index array (306A), the hierarchical data structure (302A) being used in reducing the polygon model part to be presented graphically. The invention allows an effective way to reduce the size of the polygon model part to be presented graphically such that the reduction affects the appearance of the polygon model as little as possible.

### FIELD

The invention relates to a method for processing a computer aided polygon model, a device for processing a computer aided polygon model, and a computer program for processing a polygon model.

### BACKGROUND

Computer aided graphics requires large computation and memory resources of the devices used. One way to decrease the need for said resources is to utilize in graphic representations different polygon models in which graphic structural entities are generated by means of image elements, for instance triangles.

In computer applications according to the prior art, a polygon model is formed by using a vertex data structure and an index data structure. A vertex data structure comprises the vertices of the image elements of the polygon model and is typically linear and static. The elements of the index data structure typically point at the elements of the vertex structure, associating the vertices in the vertex structure with the image elements of the polygon model. An index data structure typically comprises an active part, the elements of which determine the polygon model part to be presented graphically.

To decrease the need for computation and memory resources related to processing the polygon model part to be presented graphically, it may be necessary to modify this polygon model part. The modification may be carried out by removing vertices from the image space, changing at the same time connections between vertices. In practice, this is typically done by modifying the active part of the index array.

In this context, the intention is to carry out the modification in such a way that it affects the appearance of the polygon model part to be presented graphically as little as possible. The index data structure and the vertex data structure may contain millions of elements, and it is thus useful to contemplate some effective ways to carry out computer aided polygon model processing related to modifying the polygon model part to be presented graphically.

### BRIEF DESCRIPTION

An object of the invention is to implement a method, a device implementing the method and a computer program implementing the method in such a way that an effective way to process a polygon model is achieved. This is achieved with a method for processing a computer aided polygon model. The method according to the invention comprises forming a vertex array which is linear and static and comprises the vertices of the image elements of the polygon model; forming an index array which is linear and the elements of which determine the image elements of the polygon model by pointing at the vertices of the image elements in the vertex array, and which index array comprises an active part, the image elements determined by the elements of the active part being included in the polygon model part to be presented graphically; forming a hierarchical data structure whose hierarchy is based on the division of the vertices in the image space, the nodes of which hierarchical data structure point at nodes of a lower level in the hierarchy, the leaf nodes of the hierarchical data structure pointing at elements of the active part of the index array; and reducing the polygon model part to be presented graphically by means of the hierarchical data structure, maintaining the linearity of the index array.

An object of the invention is also a device for processing a computer aided polygon model. The device according to the invention comprises a vertex array which is linear and static and comprises the vertices of the image elements of the polygon model; an index array which is linear and the elements of which determine the image elements of the polygon model by pointing at vertices of the image elements, and which index array comprises an active part, the image elements determined by the elements of the active part being included in the polygon model part to be presented graphically; a hierarchical data structure whose hierarchy is based on the division of the vertices in the image space, the nodes of which hierarchical data structure point at nodes of a lower level in the hierarchy, the leaf nodes of the hierarchical data structure pointing at the elements of the active part of the index array; and a processing unit connected to the index array, the hierarchical data structure and the vertex array to reduce the polygon model part to be presented graphically by means of the hierarchical data structure, maintaining the linearity of the index array.

A further object of the invention is a computer program for processing a polygon model, which computer program is embodied in a distribution medium readable by a computer. The computer program according to the invention comprises: a vertex array which is linear and static and which includes the vertices of the image elements of the polygon model; an index array which is linear and the elements of which determine the image elements of the polygon model by pointing at the vertices of the image elements, and which index array comprises an active part, the image elements determined by the elements of the active part being included in the polygon model part to be presented graphically; a hierarchical data structure whose hierarchy is based on the division of the vertices in the image space, the nodes of which hierarchical data structure point at nodes of a lower level in the hierarchy, the leaf nodes of the hierarchical data structure pointing at the elements of the active part of the index array; and computer-executable commands to reduce the polygon model part to be presented graphically by means of the hierarchical data structure, maintaining the linearity of the index array.

Preferred embodiments of the invention are disclosed in the dependent claims.

The invention is based on directing indirect pointing from a hierarchical data structure at a vertex array, formed by pointing at an index array with elements of the hierarchical data structure and further by pointing from the index array at the vertex array. The hierarchical data structure includes, coded in its hierarchical structure, the detail information included in the vertex array, this information being used as the basis for the reduction of the polygon model.

A plurality of advantages is achieved with the method, device and computer program according to the invention. One advantage is quick processing of a polygon model, because there is no need to go through the elements of the vertex and index arrays in conjunction with the reduction but the vertices determined by the hierarchy can be removed by modifying the index array on the basis of the detail information included in the hierarchical data structure.

### LIST OF FIGURES

The invention will now be described in connection with preferred embodiments, with reference to the attached drawings, of which

FIG. 1A shows a first example of a polygon model;

FIG. 1B shows a second example of a polygon model;

FIG. 2 shows an example of a vertex array and an index array;

FIG. 3A shows a first example of a vertex array, an index array and a hierarchical data structure;

FIG. 3B shows a second example of a vertex array, an index array and a hierarchical data structure;

FIG. 4 shows an example of an embodiment of a device according to the presented solution;

FIG. 5 shows a first example of embodiments of a method according to the presented solution;

FIG. 6 shows a second example of embodiments of the method according to the presented solution; and

FIG. 7 shows a third example of embodiments of the method according to the presented solution.

### DESCRIPTION OF EMBODIMENTS

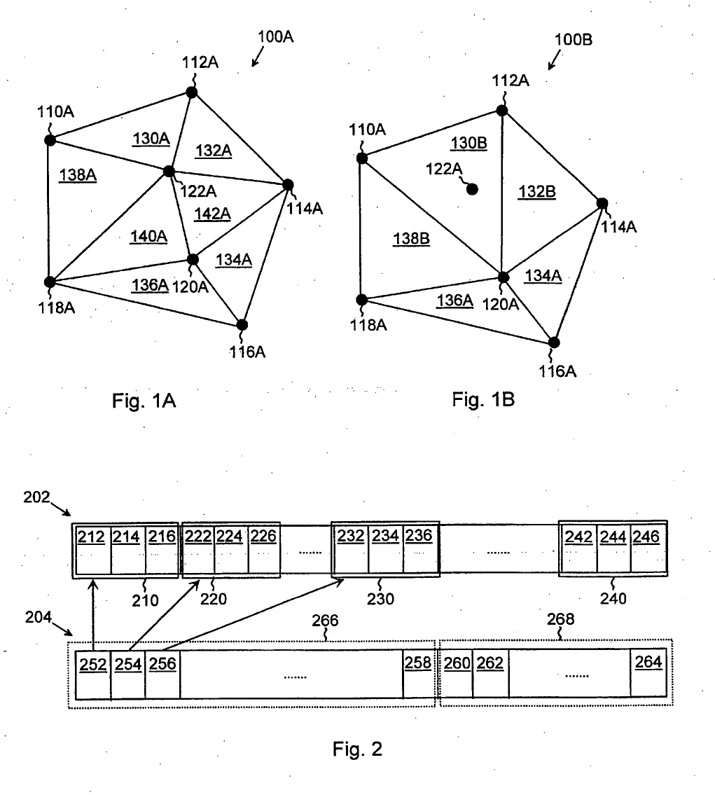

In FIG. 1A, a polygon model 100A according to an embodiment of the presented solution is examined. In the presented example, a two-dimensional polygon model 100A is examined whose image elements 130A, 132A, 134A, 136A, 138A, 140A, 142A are triangles. The polygon model is a collection of image elements by means of which the desired graphic object, such as a geometric figure, is presented. The presented solution is not, however, restricted to a two-dimensional polygon model but may as well involve a polygon model with more dimensions.

The image elements 130A to 142A of the polygon model 100A are determined by vertices 110A, 112A, 114A, 116A, 118A, 120A, 122A when the vertices 110A to 122A are connected in a desired manner. Each vertex 110A to 122A can function as a vertex for more than one image element 130A to 142 A. The vertex is also known as an extreme point and the vertex array as an extreme point array.

FIG. 1B shows a graphic representation of the polygon model of FIG. 1A after the polygon model 100A part to be presented graphically has been modified. The vertices 110A to 122A of the polygon model have stayed unchanged in the modification, but the connectivity information of the vertices 110A to 122A has changed in such a way that the vertex 122A is not connected to any image element in FIG. 1B. As a result of the modification, three triangles disappear from the polygon model part to be presented graphically, and the triangles 130A, 132A, 138A and 142A are replaced with triangles 130B, 132B and 138B. Thus, the edges associated with the vertex 122A of the polygon model 100A has been made collapse, and the opening formed in the collapse of the edges has been filled by changing the connectivity information of the polygon model. As a result of the modification, the elaborateness of the polygon model has changed, but the visual appearance has remained recognizable. By correspondingly removing or adding vertices from the polygon model part to be presented and by changing the connectivity information of the vertices, the graphic manifestation of the polygon model may be elaborated or coarsened.

FIG. 2 illustrates an example of a linear vertex array 202, which contains vertices 210, 220, 230 and 240 of the image elements of a three-dimensional polygon model. In the three-dimensional presentation, each vertex 210, 220, 230 and 240 is typically formed of an x, y, and z vertex coordinate positioned successively in a known order relative to each other, whereby in order to point at each vertex 210, 220, 230, 240, information on the position of one vertex coordinate of the vertex 210, 220, 230, 240 in question in the linear vertex array 202 is sufficient. For example, the vertex coordinates of the vertices 210, 220, 230, 240 are (212, 214 and 216), (222, 224, 226), (232, 234, 236) and (242, 244, 246) in this order. The vertices 210, 220, 230 and 240 may be located, relative to each other, at any point of the linear vertex array 202, as far as the location of the vertices 210, 220, 230, 240 is known. In an embodiment, the elements of the linear vertex array 202 are floating point numbers. The number of vertices 210, 220, 230, 240 depends on the size of the polygon model and the computer memory capacity used.

In the presented solution, the linear vertex array 202 is static. The linearity of the linear vertex array 202 means, in this context, that the vertex array 202 is a one-dimensional array whose elements form an uninterrupted data structure in the memory space. The linear vertex array 202 being static means, in this context, that the linear vertex array 202 remains unchanged when the polygon model is processed. Thus, the memory pointing of the vertex coordinate of each vertex 210, 220, 230, 240 in the linear vertex array 202 remains unchanged.

FIG. 2 shows an example of a linear index array 204, whose elements 252, 254, 256, 258, 260, 262, 264 define the image elements of the polygon model. Each element 252 to 264 of the index array 204 points at one of the vertices 210, 220, 230, 240 of the linear vertex array 202 in such a way that one edge of the image element to be associated to the specific element of the linear index array 204 is plotted through the vertex 210, 220, 230, 240 pointed at.

Let us assume, for example, that a triangle-shaped image element is defined by the vertices 210, 230 and 240. Thus, the linear index array 204 has three references to the linear vertex array 202, and the image element is defined by means of a linear index array 204 in such a way that the element 252 of the linear index array 204, for instance, points at the memory location of the linear vertex array 202, which contains the coordinates 212, 214 and 216 of the vertex 210. Correspondingly, the element 254 of the linear index array 204, for instance, points at the memory location of the linear vertex array 202, which memory location returns the coordinates 222, 224 and 226 of the vertex 220. Further, the element 256 of the linear index array 204, for instance, points at the memory location of the linear vertex array 202, which memory location returns the coordinates 232, 234 and 236 of the vertex 230.

In an embodiment, the elements of the linear index array 204 that define the same image element are positioned successively in the linear index array 204. The elements of the linear index array 204 are integer number variables.

In the presented solution, the linear index array 204 comprises an active part 266, the image elements determined by the elements 252 to 258 of the active part being included in the polygon model part to be presented graphically. The part of the polygon model to be presented graphically comprises those image elements that are shown in the graphic user access of the computer or transmitted in a data network to another computer. In the display process of the polygon model part to be presented graphically, the elements 252 to 258 of the active part 266 of the linear index array 204 are gone through.

FIG. 2 also shows the passive part 268 of the index array 204. The image elements determined by elements 260, 262, 264 of the passive part 268 belong outside the part to be presented graphically, and therefore these image elements are not presented graphically.

In an embodiment, the active part 266 is formed in the memory space in such a way that it forms a linear memory block whose first and second memory address is known, and the passive part 268 forms a linear memory block after the active part 266 in such a way that the index array 202 fills a uniform memory space. Thus, the polygon model part to be presented graphically can be picked up from the index array 202 when only the beginning of the active part 266 in the memory space and the size of the active part 266 are known. This feature significantly accelerates the functioning of the computer display adapter, for instance.

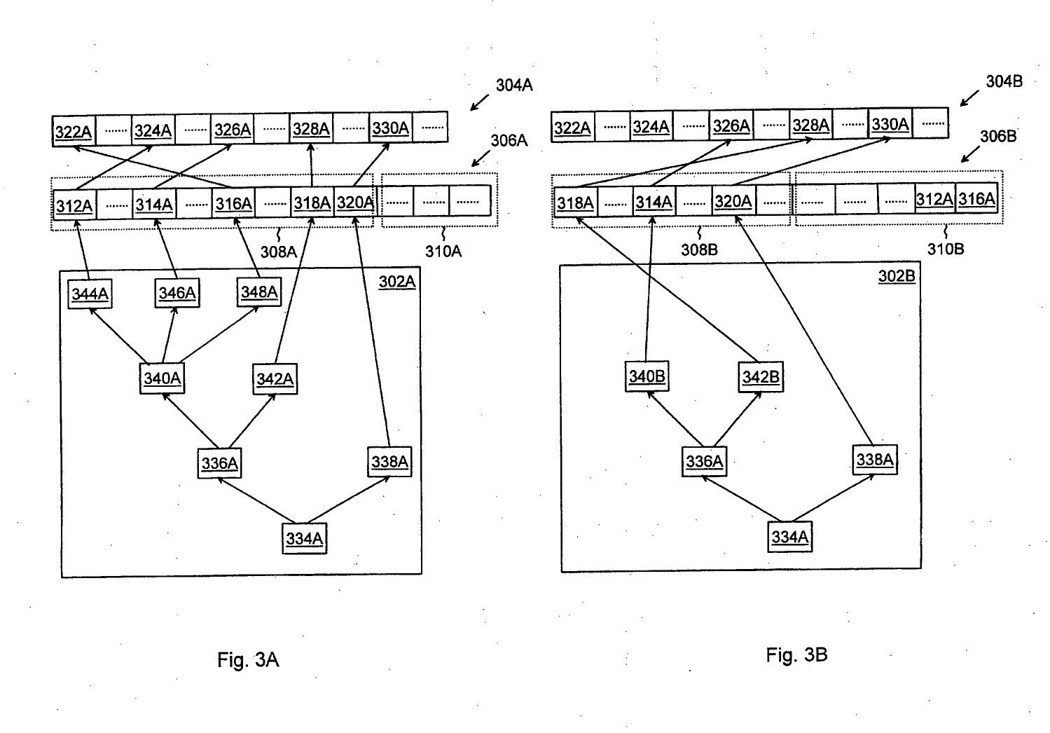

The example of FIG. 3A shows a linear index array 304A, a linear index array 306A and a hierarchical data structure 302A.

The linear index array 306A of the example comprises elements 312A, 314A, 316A, 318A, 320A, which point at elements 324A, 326A, 322, 328A, 330A of the vertex array 304A, in this order. The elements 322A to 330A of the vertex array 306A may be, for example, x components of vertices, whereby the x and y coordinates are obtained from the mutual order of the coordinates. Correspondingly, each of the elements 312A to 320A of the index array 306A may represent one triangle, in which case the other two indices are obtained from the first one, based on the order of the elements in the index array 306A, for example. In the example, the elements 312A to 320A belong to the active part 308A of the index array, whereby the vertices 322A to 330A are presented graphically. The index array 306A additionally comprises a passive part 310A, whose elements are not shown separately in FIG. 3A.

The hierarchical data structure 302A of the example comprises elements 334A, 336A, 338A, 340A, 342, 344A, 346A, 348A.

The element 334A of the hierarchical data structure 302A is a root node that is on the uppermost level in the hierarchy. The root node 334A comprises pointers at the nodes 336A, 338A of the next lowest level in the hierarchy.

In an embodiment, the hierarchical data structure 320A is an Octree, in which each node has eight child nodes. In computer graphics, an Octree is used for recursively dividing a three-dimensional space into subspaces. Each subspace can be divided with an Octree in such a way that a node corresponds to the space, and each of the eight child nodes of the node corresponds to one sector that is generated when the space is divided into two subspaces in the direction of each coordinate axis.

The node 338A in the example is a node of the lowest hierarchy level of the subtree in question, i.e. a leaf node. The leaf node 338A comprises a pointer to the element 320A of the index array 306A. Thus, the leaf node 338A points indirectly to the element 330A of the vertex array 304A through the element 320A of the index array 306A.

The node 336A comprises pointers at the nodes 340A and 342A of the next lowest level in the hierarchy, of which the node 342A is a leaf node and comprises a pointer at the node 318A of the index array. Thus, the leaf node 342A points indirectly at the element 328A of the vertex array 304A through the element 318A of the index array 306A.

The node 340A comprises pointers at the leaf nodes 344A, 346A, 348A that comprise pointers at the elements 312A, 314A, 316A of the active part 308A of the index array 306A, in this order. The leaf nodes 344A, 346A, 348A point indirectly through the elements 312A, 314A, 316A of the index array 306A at the elements 324A, 326A, 322A of the vertex array 304A, in this order.

There are eight leaf nodes 344A to 348A in the Octree, and they determine the vertex coordinates of the smallest volume element of the branch in question.

The hierarchy of the hierarchical data structure 302A is typically based on the division of the vertices 322A to 330A in the image space. The hierarchical data structure 302A may be formed, for example, by dividing the coordinate space presented by the polygon model into hierarchical sectors on the basis of the vertices 322A to 330A included in the vertex array 304A. The hierarchical sectors are typically three-dimensional structures limited by vertices, where the hierarchically lower structures are hierarchically within the upper structures. Each hierarchical sector is represented by one node 334A to 348A of the hierarchical data structure 302A, in which the pointers of the nodes corresponding the sectors of the next lowest level in the hierarchy are included. The pointers pointing at the elements of the index array 206A pointing at the vertices of the lowest hierarchical sector are included in the leaf nodes 338A, 342A, 344A to 348A.

In the presented solution, the polygon model part to be presented graphically is reduced by means of the hierarchical data structure 302A, maintaining the linearity of the index array 306A.

FIG. 3B shows an example of a final situation where the polygon model part to be presented graphically, as presented in FIG. 3A, has been reduced. The situation may correspond to the example presented in FIGS. 1A and 1B, in which the vertex 122A has been removed from the polygon model part to be presented graphically, and the connectivity between the remaining vertices has been changed in such a way that the triangles fill the image space.

The example of FIG. 3B represents a situation where the polygon model part to be presented graphically has been reduced by removing at least two hierarchically equal leaf nodes 344A to 348A of FIG. 3A. At the same time, the location information representing the vertices 324A, 326A, 322A pointed at by the elements 312A, 314A, 316A of the index array 306A pointed at by said at least two leaf nodes 344A, 346A, 348A is included in a node 340B on a lower level in the hierarchy, whereby this lower-level node 340B becomes a leaf node. In addition, at least one element 312A, 314A, 316A of the index array 306A pointed at by said at least two leaf nodes 344A, 346A, 348A of the same hierarchical level is removed from the active part 308A. Each triangle removed from the active part 308A requires moving of three elements of the index array 206A from the active part 308A. The vertex array 304B remains unchanged.

The location information representing the vertices 324A, 326A, 322A pointed by the elements 312A, 314A, 316A, can be selected in a plurality of ways. In one embodiment, the elements 312A, 314A, 316A are identified with one of the removed elements 312A, 314A, 316A. In the example, the elements 312A, 314A, 316A are identified with the element 314A, whereby the vertex 326A represents the vertices 324A, 326A, 322A after the reduction. The representative element of the index array may be selected randomly, or the selection may be based on a coordinate analysis of the vertices 324A, 326A, 322A to be removed from the graphical representation.

To maintain the linearity of the index array 306A, the elements 312A to 316A removed from the active part 308A of the index array 306A can be replaced with other elements moved from, for example, the end of the active part 308A, reducing at the same time the size of the active part 308 in such a way that no empty memory locations are brought about. This results in the index array 308B of FIG. 3B, in the active part of which the element 314A remains in its original place, whereas the elements 318A and 320A are moved to the places of the elements 312A and 316A in this order.

The elements 312A, 316A can be removed in such a way that they are moved from the active part 306A to the passive part 306A. Thus, the final result is the passive part 310B of FIG. 3B, which comprises the elements 312A, 316A. Thus, the size of the passive part 306B has also increased compared to the size of the passive part 310A of the passive part 3A.

Linearization of an index array typically requires modifications also in the hierarchical data structure 302B. The nodes 334A and 336A can be kept unchanged, but the values of the pointers included in the nodes 338B, 340B, 342B of FIG. 3 corresponding to the nodes 338A, 340A, 342A of FIG. 3A change to correspond to the pointers of the elements 318A and 320A in the index array 306B.

The index array 306A can be modified by means of an LOD object (LOD, Level-of-Detail). The LOD object utilizes the hierarchy information between the nodes, included in the hierarchical data structure 302A, and implements an LOD algorithm, which is capable of adding and/or removing polygon model details. The LOD object typically encodes the modifications of the polygon model in the memory of the device for inversion. Thus, the LOD object includes the information on which elements of the index array 306A have been modified.

Owing to the presented solution, in constructing an LOD object there is no need to go through the whole index array 306A, because the modification is focused directly on the elements determined by the hierarchical data structure 302A. Furthermore, the active part 308A is reorganized by means of the LOD object.

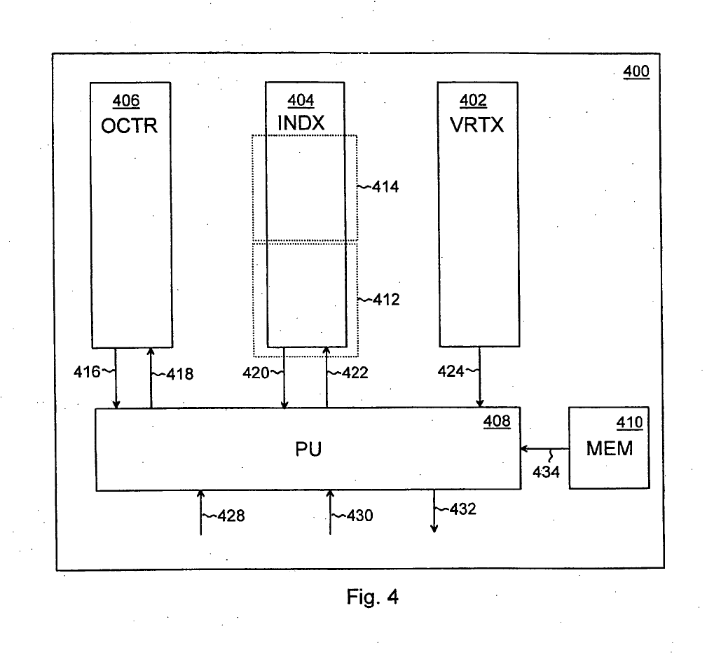

Referring to FIG. 4, a device 400 according to the presented solution comprises a linear and a static vertex array (VRTX) 402, a linear index array (INDX) 404, a hierarchical data structure (OCTR) 406 and a processing unit (PU) 408 that is connected to the vertex array 402, the index array 404 and the hierarchical data structure 406. In addition, the device 400 comprises a memory unit (MEM) 410 for storing a programming code.

The vertex array 402, the index array 404 and the hierarchical data structure 406 can be implemented by means of a memory unit 410 or a memory block allocated separately for the vertex array 402, the index array 404 and the hierarchical data structure 406. It is obvious to a person skilled in the art how to implement these data structures and carry out their memory pointing. An example of the relations between the vertex array 402, index array 404 and hierarchical data structure 406 is shown in FIGS. 2, 3A and 3B.

The processing unit 408 carries out the reduction of the polygon model part to be presented graphically by means of the hierarchical data structure 406 in such a way that the linearity of the index array 404 is maintained.

The processing unit 408 receives a data stream 428 that includes the coordinates 212 to 244 of the vertices and information on how the vertices are connected to form image elements.

The processing unit 408 forms the vertex array 402 and the index array 404 on the basis of the data stream 428.

The processing unit 408 additionally forms the hierarchical data structure 406 on the basis of the division of the vertices in the image space.

The processor can form the vertex array 402, the index array 404 and the hierarchical data structure on the basis of commands contained in a computer program 434 loaded from the memory unit 410, for example.

Let us assume that the vertex array 402, the index array 404 and the hierarchical data structure 406 have been formed. A polygon model part 432 to be presented graphically can be formed by loading elements 420 of the active part of the index array 404 to the processing unit 408 and by loading vertices 424 pointed at by the elements 420 from the vertex array 402.

The polygon model part 432 to be presented graphically can be outputted for instance to the computer display adapter.

In an embodiment, the processing unit 408 receives a modification command 430 that includes an instruction to reduce the polygon model part to be presented graphically.

The intention of the modification command 430 is, for example, to achieve the reduction of the polygon model part to be presented graphically in such a way that the visual manifestation of the polygon model changes as little as possible. The polygon model part to be presented graphically determines, for instance, the load which has been set for the computer graphics and which can be adjusted by modifying the polygon model part to be presented graphically and/or the size of the polygon model. For example in the transformation, such as rotation, of CAD images (CAD; Computer Aided Design), the vertices of the vertex array are subjected to mathematical operations that may be computationally very heavy in the case of large polygon models. In such a case, image elements of the polygon model part to be presented graphically must be removed, which results in reduced accuracy of the visual manifestation of the polygon model.

Having received the modification command 430, the processing unit 408 starts executing the algorithm relating to an LOD object. The processing unit 408 can compare the hierarchy of the leaf nodes of different subtrees and deduce the priorities of the leaf nodes to be removed on the basis of the hierarchy. The leaf nodes of the lowest hierarchy typically point at the sectors of the highest accuracy, the removal of which from the image space causes the smallest change in the graphical manifestation of the polygon model.

The processing unit 408 can input elements 416 of the leaf nodes to be removed and move index array elements 422 pointed at by the elements 416 from the active part 412 of the index array 404 to the passive part 414. In addition, the processing unit 408 can reorganize the index array 404 in such a way that the linearity of the index array 404 is maintained.

Further, the processing unit 408 can modify the hierarchical data structure 406 according to the example of FIG. 3B by positioning, for instance, pointers 418 of the index array 404 in nodes of the hierarchical data structure.

In an embodiment, the processing unit 408 removes at least two hierarchically equal leaf nodes from the hierarchical data structure 406. In addition, the processing unit 408 includes the location information representing the vertices pointed at by index array elements pointed at by said at least two leaf nodes in a node of an upper level in the hierarchy, whereby this upper level node becomes a leaf node. Furthermore, the processing unit 408 removes at least one index array element pointed at by said at least two hierarchically equal leaf nodes from the active part of the index array.

The device 400 for processing a computer aided polygon model, shown in FIG. 4, can be implemented for instance as part of the display adapter of a computer, display adapter of a digital television or display adapter of a terminal in a radio system. The above display adapters may be considered to have a digital computer comprising the following main parts: a central processing unit (CPU) and a working memory. The central processing unit can comprise three main parts: registers, an arithmetic-logical unit and a control unit. The data structures and programs needed in the processing can be implemented with different programming languages. Configuration can be implemented by programming, i.e. preparing software and data structures containing the required functionality, but also pure hardware solutions for instance with integrated circuits are feasible. Also mixed operation is feasible, where certain functionalities are implemented as hardware implementation, whereas part is implemented by software. When selecting the manner of implementation, a person skilled in the art will take into account the criteria set for, for instance, the size and price of the device, as well as other factors.

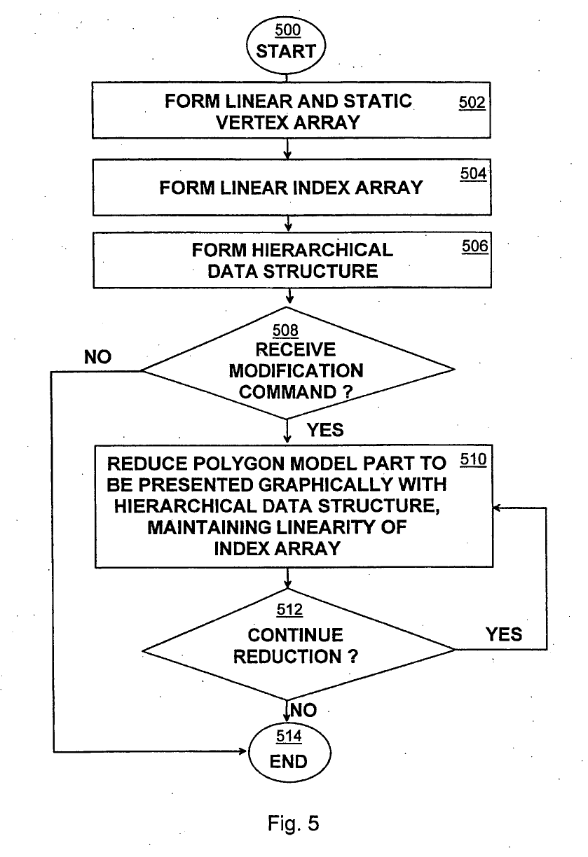

Referring to FIGS. 5, 6 and 7, embodiments of the presented solution are now viewed.

In FIG. 5, the method starts at 500.

At 502, the vertex array 304A is formed that is linear and static, comprising the vertices 322A to 330A of the image elements of the polygon model.

At 504, the index array 306A is formed which is linear and whose elements 312A to 320A determine the image elements of the polygon model by pointing at the vertices of the image elements in the vertex array 304A, and which index array 306A comprises an active part 308A, the image elements determined by the elements of the active part being included in the polygon model part to be presented graphically.

At 506, the hierarchical data structure 302A is formed, the hierarchy of which is based on the division of the vertices 322A to 330A in the image space, the nodes 334A, 336A, 340A of the hierarchical data structure pointing at nodes of a lower level in the hierarchy, and the leaf nodes 342A, 338A, 344A, 346A, 348A of the hierarchical data structure pointing at elements of the active part 308A of the index array 306A.

At 508, the method is divided into two cases. In the first case, a modification command 430 is not received. Thus, the method ends at 514. After the termination, the method may begin from the start if the polygon model changes.

In the second case, the modification command is received. Thus, at 510, the polygon model part to be presented graphically is reduced by means of the hierarchical data structure 302A, maintaining the linearity of the index array 306A.

The decision on continuing or ending the reduction is made at 512. If the reduction is continued, the measures of 510 are carried out by directing the reduction at the existing index array 306B by using the existing hierarchical data structure 302B. If the reduction is not continued, the method is terminated at 514.

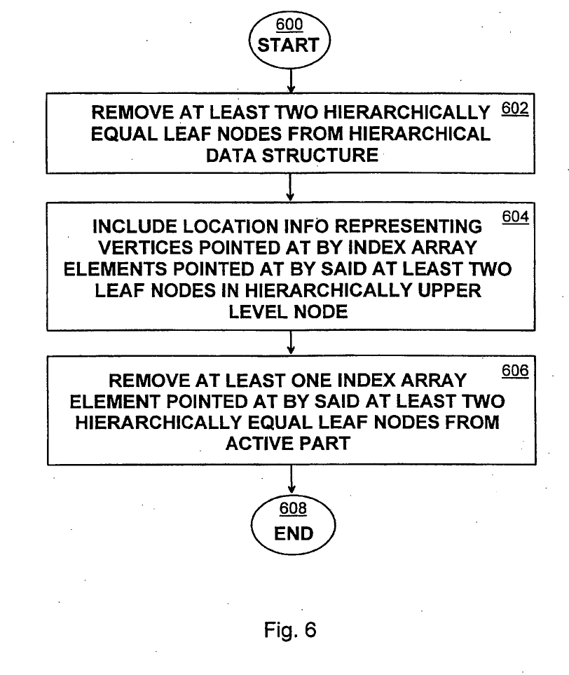

The flow chart of FIG. 6 shows an example of embodiments of the reduction step 510.

The method starts at 600.

At 602, at least two hierarchically equal leaf nodes 344A to 346A are removed from the hierarchical data structure 302A.

At 604, the location information representing the vertices 324A, 326A, 322A pointed at by the index array elements 312A, 314A, 316A pointed at by the at least two leaf nodes 344A to 346A is included in the node 340B of an upper level in the hierarchy, whereby this upper level node 340B becomes a leaf node.

At 606, at least one element of the index array 312A, 314A, 316A pointed at by said at least two hierarchically equal leaf nodes 344A to 346A is removed from the active part 308A.

The method is ended at 608.

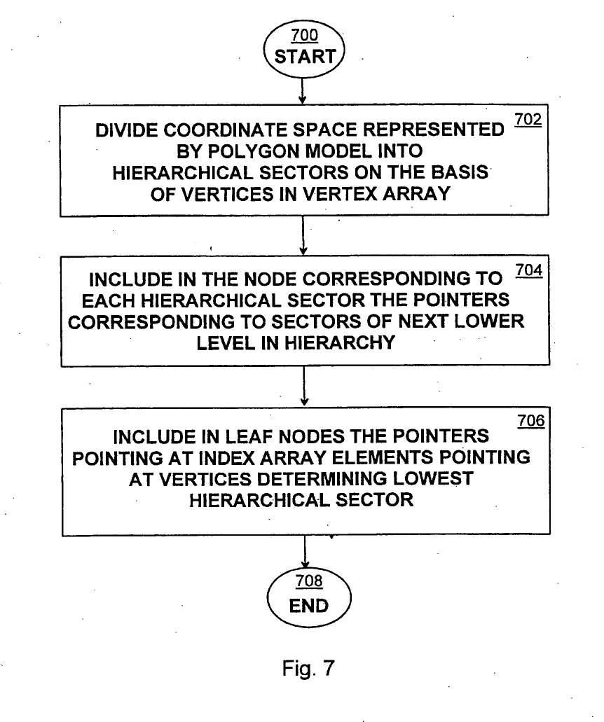

The flow chart of FIG. 7 shows an example of embodiments of forming a hierarchical data structure.

The method starts at 700.

At 702, the coordinate space represented by the polygon model is divided into hierarchical sectors on the basis of the vertices contained in the vertex array 304A.

At 704, the pointers of the nodes corresponding to the sectors of the next lowest level in the hierarchy are included in the node 334A, 336A, 340A corresponding to each hierarchical sector.

At 706, the pointers pointing at the index array elements 316A, 312A, 314A pointing at the vertices 322A, 324A, 326A determining the lowest hierarchical sector are included in the leaf nodes 344A to 346A.

The method is ended at 708.

One aspect of the invention is that is provides a computer program for executing a computer process, the computer program being embodied in a distribution medium readable by a computer.

The computer process can be implemented according to the method embodiments shown in FIGS. 5, 6 and 7 by using data structures encoded in the computer program, such as the vertex array 304A, index array 306A and hierarchical data structure 302A.

The computer program can be executed in the processor unit 408 of the device 400 and stored in the memory unit 410.

The computer program according to the invention can be stored and distributed by using different distributing media and mass memories. These include, for example, the Internet, hard disks, optical record disks, such as CD (Compact Disk), memory cards and magnetic tapes.

Although the invention is described above with reference to the example according to the attached drawings, it is obvious that the invention is not restricted to it but can be modified in a plurality of ways within the scope of the attached claims.

1. A method for processing a computer aided polygon model, comprising:
forming (502) a vertex array which is linear and static and comprises the vertices of the image elements of the polygon model;
forming (504) an index array which is linear and the elements of which determine the image elements of the polygon model by pointing at the vertices of the image elements in the vertex array, and which index array comprises an active part, the image elements determined by the elements of the active part being included in the polygon model part to be presented graphically; characterized by
forming (506) additionally a hierarchical data structure whose hierarchy is based on the division of the vertices in the image space, the nodes of which hierarchical data structure point at nodes of a lower level in the hierarchy, the leaf nodes of the hierarchical data structure pointing at elements of the active part of the index array; and
reducing (510) the polygon model part to be presented graphically by means of the hierarchical data structure, maintaining the linearity of the index array.

2. A method according to claim 1, characterized by reducing (510) the polygon model by
removing (602) at least two hierarchically equal leaf nodes from the hierarchical data structure;
including (604) the location information representing the vertices pointed at by the index array elements pointed at by said at least two leaf nodes in a node of an upper level in the hierarchy, whereby this upper level node becomes a leaf node; and
removing (606) at least one element of the index array pointed at by said at least two hierarchically equal leaf nodes from the active part.

3. A method according to claim 1, characterized by forming (504) an index array in such a way that the index array also comprises a passive part, the vertices pointed at by the elements of the passive part belonging outside the polygon model part to be presented graphically; and
reducing (510) the polygon model part by moving at least one index array element from the active part to the passive part.

4. A method according to claim 1, characterized by forming (506) a hierarchical data structure by:
dividing (702) the coordinate space represented by the polygon model into hierarchical sectors on the basis of vertices contained in the vertex array;
including (704) the pointers of the nodes corresponding to the sectors of the next lowest level in the hierarchy in the node corresponding to each hierarchical sector;
including (706) the pointers pointing at the index array elements pointing at the vertices determining the lowest hierarchical sector in the leaf nodes.

5. A device for processing a computer aided polygon model, characterized in that the device comprises:
a vertex array (402) which is linear and static and comprises the vertices of the image elements of the polygon model;
an index array (404) which is linear and the elements of which determine the image elements of the polygon model by pointing at the vertices of the image elements, and which index array (404) comprises an active part (412), the image elements determined by the elements of the active part being included in the polygon model part to be presented graphically; and
a hierarchical data structure (406) whose hierarchy is based on the division of the vertices in the image space, the nodes of which hierarchical data structure (406) point at nodes of a lower level in the hierarchy, the leaf nodes of the hierarchical data structure (406) pointing at elements of the active part (412) of the index array (404); and
a processing unit (408) connected to the index array (404), the hierarchical data structure (406) and the vertex array (402) to reduce the polygon model part to be presented graphically by means of the hierarchical data structure (406), maintaining the linearity of the index array (404).

6. A device according to claim 5, characterized in that the processing unit (408) is arranged to remove at least two hierarchically equal leaf nodes from the hierarchical data structure (406);
the processing unit (408) is arranged to include the location information representing the vertices pointed at by the index array elements pointed at by at least two leaf nodes in a node of an upper level in the hierarchy, whereby this upper level node becomes a leaf node; and
the processing unit (408) is arranged to remove at least one index array element pointed at by said at least two hierarchically equal leaf nodes from the active part.

7. A device according to claim 5, characterized in that the index array (404) further comprises a passive part (414), the vertices pointed at by the elements of the passive part belonging outside the polygon model part to be presented graphically; and
the processing unit (408) is arranged to reduce the polygon model by moving at least one index array element from the active part (412) to the passive part (414).

8. A device according to claim 5, characterized in that the hierarchical data structure (406) includes hierarchical sectors based on vertices of the vertex array;
the node corresponding to each hierarchical sector includes the pointers of the nodes corresponding to the sectors of the next lowest level in the hierarchy; and
the leaf nodes of the hierarchical data structure (406) include pointers pointing at the index array elements pointing at the vertices determining the lowest hierarchical sector.

9. A computer program for processing a polygon model, which computer program is embodied in a distribution medium readable by a computer, characterized in that the computer program comprises:
a vertex array (402) which is linear and static and which includes the vertices of the image elements of the polygon model;
an index array (404) which is linear and the elements of which determine the image elements of the polygon model by pointing at the vertices of the image elements, and which index array (404) comprises an active part (412), the image elements determined by the elements of the active part being included in the polygon model part to be presented graphically;
a hierarchical data structure (406) whose hierarchy is based on the division of the vertices in the image space, the nodes of which hierarchical data structure point at nodes of a lower level in the hierarchy, the leaf nodes of the hierarchical data structure pointing at elements of the active part (412) of the index array; and
computer-executable commands to reduce (508) the polygon model part to be presented graphically by means of the hierarchical data structure, maintaining the linearity of the index array.

10. A computer program according to claim 9, characterized in that the computer program comprises:
a computer-executable command (602) to remove at least two hierarchically equal leaf nodes from the hierarchical data structure;
a computer-executable command to include (604) the location information representing the vertices pointed at by the index array elements pointed at by said at least two leaf nodes in the node of an upper level in the hierarchy, whereby this upper level node becomes a leaf node; and
a computer-executable command to remove (606) at least one element of the index array pointed at by said at least two hierarchically equal leaf nodes from the active part (412).

11. A computer program according to claim 9, characterized in that the index array (404) further comprises a passive part (414), the vertices pointed at by the elements of the passive part belonging outside the polygon model part to be presented graphically; and
the computer program includes a computer-executable command to reduce (508) the polygon model by moving at least one index array element from the active part (412) to the passive part (414).

12. A computer program according to claim 9, characterized in that the hierarchical data structure (406) includes hierarchical sectors based on vertices of the vertex array;
the node corresponding to each hierarchical sector includes the pointers of the nodes corresponding to the sectors of the next lowest level in the hierarchy; and
the leaf nodes of the hierarchical data structure (406) include pointers pointing at the index array elements pointing at the vertices determining the lowest hierarchical sector.
